(19) United States
(12) Patent Application Publication
(10) Pub. No.: US 2012/0147509 A1
(43) Pub. Date: Jun. 14, 2012

(54) TBF Compatible with Input Power Including GFCI

(75) Inventors: Bahram Mechanic, Houston, TX (US); Tooraj Faridi, Houston, TX (US)

(73) Assignee: SMARTPOWER SYSTEMS, INC., Houston, TX (US)

(21) Appl. No.: 12/963,330

(22) Filed: Dec. 8, 2010

(51) Int. Cl. H02H 3/20

(52) U.S. Cl. 361/49

(57) ABSTRACT

A protective circuit having hot, neutral, and ground leads arranged to be placed between corresponding hot, neutral, and ground leads of a power utility outlet and corresponding hot, neutral, and ground leads of electrical apparatus.

### 1. BACKGROUND

This disclosure relates to electrical protective filters or transient voltage surge suppressors (TVSS) for office equipment or any microprocessor-based equipment. These suppressors provide surge filtration to protect the office equipment from surges or transients in the power furnished from the power distribution network. Examples of TVSS are disclosed in U.S. Pat. Nos. 5,721,661 and 6,229,682, the disclosures of which are incorporated herein by references.

### BRIEF DESCRIPTION OF THE DRAWINGS

FIG. 1 is a schematic illustration of an exemplary embodiment of a transient voltage surge suppressor or transformer base filter.

FIGS. 2A-2B are a schematic illustration of an exemplary embodiment of a transient voltage surge suppressor or transformer base filter that is compatible with a ground fault circuit interrupter.

FIGS. 3A-3B are a schematic illustration of an exemplary embodiment of a transient voltage surge suppressor or transformer base filter that is compatible with a ground fault circuit interrupter.

FIGS. 4A-4B are a schematic illustration of an exemplary embodiment of a transient voltage surge suppressor or transformer base filter that is compatible with a ground fault circuit interrupter.

FIG. 5 is a graphical illustration of an exemplary experimental embodiment of the transient voltage surge suppressor or transformer base filter of FIG. 1.

FIG. 6 is a graphical illustration of exemplary experimental embodiments of the transient voltage surge suppressor or transformer base filters of FIGS. 2A, 2B, 3A, 3B, 4A, and 4B.

FIG. 7 is a graphical illustration of exemplary experimental embodiments of the transient voltage surge suppressor or transformer base filters of FIGS. 2A, 2B, 3A, 3B, 4A, and 4B.

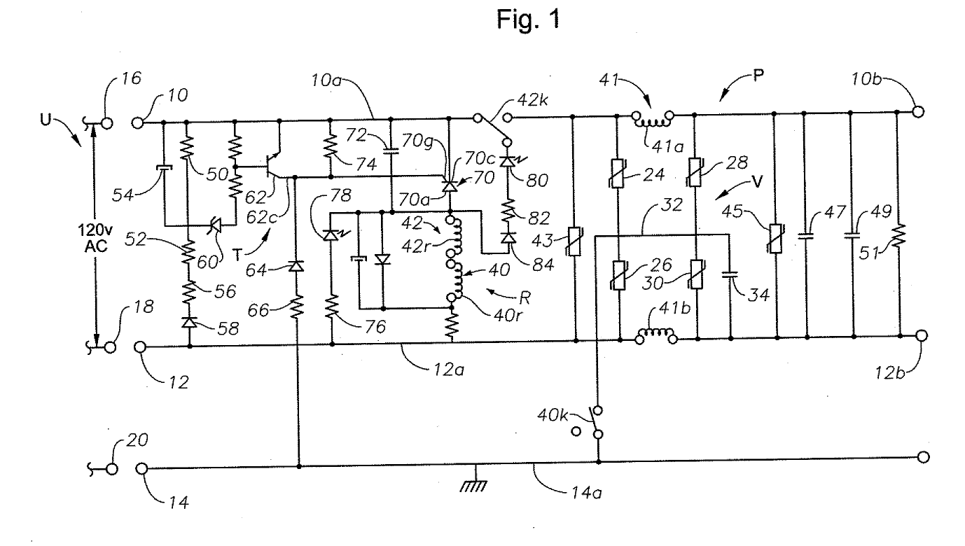

### DETAILED DESCRIPTION

In the drawings and description that follows, like parts are marked throughout the specification and drawings with the same reference numerals, respectively. The drawings are not necessarily to scale. Certain features of the invention may be shown exaggerated in scale or in somewhat schematic form and some details of conventional elements may not be shown in the interest of clarity and conciseness. The present invention is susceptible to embodiments of different forms. Specific embodiments are described in detail and are shown in the drawings, with the understanding that the present disclosure is to be considered an exemplification of the principles of the invention, and is not intended to limit the invention to that illustrated and described herein. It is to be fully recognized that the different teachings of the embodiments discussed below may be employed separately or in any suitable combination to produce desired results. The various characteristics mentioned above, as well as other features and characteristics described in more detail below, will be readily apparent to those skilled in the art upon reading the following detailed description of the embodiments, and by referring to the accompanying drawings.

In the drawings, the letter P designates generally a new and improved protective circuit or transient voltage suppressor for electrical apparatus. The protective circuit P functions as a transformer base filter. In the preferred embodiment, the electrical apparatus may take the form of a computer, a copier, a facsimile machine or the like having voltage surge or transient sensitive electronic components, such as computer chips. These types of components are sensitive to voltage surges or transients, as well as abnormal high voltages furnished them by leads from electrical power utilities. It should be understood, however, that the protective circuit P may be used with other electrical apparatus which are sensitive to voltage surges or transients, or to abnormal high voltage.

The protective or transformer-based filter circuit P has as its inputs a hot lead or terminal 10, a neutral lead 12, and ground lead 14, each of which is connected respectively to a hot lead 16, a neutral lead 18 and a ground lead 20 of a conventional electrical power utility outlet U. Typically, the embodiment shown in the power provided is conventional 120 volts alternating current potential difference between the hot lead 16 and the neutral lead 18. It should be understood that the voltage level present could be some other conventional or standard voltage level.

The protective circuit P includes a voltage surge protective circuit V connected between a hot conductor 10a connected to the hot terminal 10 and neutral conductor 12a connected to the neutral lead 12. The voltage surge protective circuit V has a first set of voltage surge protective devices or clamping devices 24 and 26 and a second set of voltage surge protective devices, such as filters or clamps 28 and 30 and also a capacitor 34. Each of the two sets of voltage surge protective devices is connected in an electrical series circuit between the hot and neutral leads 10 and 12.

The series connected clamping devices 24 and 26 of the first set are connected at a node or common connection 32 to each other opposite their respective connections to the hot and neutral leads 10 and 12. Similarly, the series connected clamping devices 28 and 30 of the second set of the circuit V and also the capacitor 34 are connected to each other at the node 32 and thus to the clamping devices 24 and 26 of the first set. The node 32 is connected to the neutral lead 12 through a noise filter capacitor 34. The noise filter capacitor 34 may be any rating or capacitance value, such as 2 mf or larger.

The protective circuit P also includes a relay circuit R composed of a set of a first relay 40 and a second relay 42 connected between the hot and neutral leads 10 and 12.

As will be set forth, the relay set R protects against several undesirable conditions. The first relay 40 protects voltage surge protective devices 24, 26, 28, and 30, and capacitor 34 when ground lead 14 is not connected to building ground 20. The first relay 40 also protects these voltage surge protective devices against high voltages between hot lead 10 and ground lead 14, and also high voltages between neutral lead 12 and ground lead 14.

In addition, the second relay 42 protects voltage surge protective devices 43 and 45 between hot lead 10 and neutral lead 12 against high voltages. The second relay 42 as well protects the electrical apparatus at the output of protective circuit P against high voltages.

The first relay 40 has a relay coil 40r controlling the position of a switch arm or contact 40k. The contact 40k of the relay 40 is electrically connected between the node 32 between the voltage surge protective clamp sets 24 and 26, and 28 and 30 in an electrical circuit path or conductor 44 to a ground conductor 14a connected to the electric ground terminal 14. As long as the electric ground 14a is electrically connected to ground, and also, as long as the connection between the hot and neutral leads 10 and 12 is not reversed, the relay 40 receives current and relay contact 40k is in a closed position shown in the drawing.

When the ground wire 14a is properly connected and the hot and neutral wires are also properly connected, then thyristor 70 is on. The relays 40 turns on and first relay arm 40k closes the circuit between the ground lead 14a and node 32. In this manner any power surges or transients between ground and neutral or hot are suppressed by the voltage protective devices 24 and 26, also by devices 28 and 30 when present. Further, noise and transients also are filtered by capacitor 34. In this manner, substantially all electrical noise which may from time to time appear between the hot or neutral leads 10 or 12 and ground is filtered.

In the event an electrical connection between the ground lead 14 and building ground 20 is interrupted, or if the connection between the hot lead 10 and neutral lead 12 should become reversed, an abnormal situation is present. The voltage levels present can increase to twice their normal level. The relay 40 no longer receives current through thyristor 70 or other electronic switch, such as a transistor. In such a case, the contact 40k of the relay 40 opens and current cannot flow through voltage clamping devices 24, 26, 28 and 30 or the noise filter capacitor 34. Thus, the clamping components of the voltage surge protection circuit V are protected from increased voltage.

Winding bobbins 41a and 41b of a differential transformer (or noise isolation transformer) 41 are series connected between hot lead 10a and 10b and between neutral 12a and 12b, respectively. The noise isolation transformer 41 combines with capacitor 34 to filter the noise between the hot and ground or neutral lead and ground 20.

A voltage clamping device 43 is provided to suppress any surges or transient between hot lead 10a and neutral lead 12a and a clamping device 45 suppresses any surges and transients between hot lead 10b and neutral lead 12b. Capacitors 47 and 49 are furnished for filtering any noise between hot lead 10b and neutral lead 12b while a resistor 51 discharges the capacitors 47 and 49.

The second relay 42 of the relay circuit R includes a coil 42r which controls a switch arm or contact 42k in hot conductor 10a connecting the hot lead 16 of the electrical power utility outlet U to a hot lead output 10b connected to the electrical apparatus. So long as the relay 42 is receiving electrical current, the contact 42k is closed and electrical power is furnished at the hot lead output 10b to the electrical apparatus. In the event that current through the relay 42 is no longer present, such as when the ground connection is interrupted, or polarity between the hot lead 10 and neutral lead 12 becomes reversed, the contact 42k of the relay 42 opens. Power is thus inhibited from being present at hot lead 10b, and the electrical apparatus connected there is protected from voltage surges or transients. Also any clamping components between hot lead 10b and neutral lead 12b are protected against increased voltage.

The protective circuit P of the present invention also includes a voltage threshold sensing circuit T which detects when the voltage on the hot lead 16 of the electrical power utility outlet U exceeds a set or established voltage threshold. The voltage threshold is established by the relative impedance values of series connective resistors 50 and 52. The voltage threshold may be adjusted by selecting different impedance values for the two resistors, or by including a variable resistor or rheostat in one or both of the resistors 50 or 52. A DC filter capacitor 54 is connected in parallel with the resistor 50. The resistor 52 is electrically connected to the neutral conductor 12a and neutral lead 12 by a resistor 56. A diode 58 is present to rectify the AC voltage to DC.

A Zener diode 60 is electrically connected to resistors 50 and 52 to sense the voltage threshold level present there. As long as the voltage threshold does not exceed the established threshold, the diode 60 does not conduct. In the event that the voltage threshold level provided to diode 60 exceeds the set level, diode 60 begins to conduct and a transistor or other electrical or electronic switch 62 also begins to conduct. The transistor 62 is normally held in a non-conductive state by a diode 64 and a resistor 66.

A collector terminal 62c of the transistor 62 is connected to a gate 70g of a thyristor 70, or other suitable electronic switch, such as a transistor, connected in series with the relays 40 and 42. When the transistor 62 begins to conduct due to the threshold voltage level being exceeded, the current between the gate 70g and a cathode 70c of the thyristor 70 is drawn to zero. Thyristor 70 is then switched to a non-conductive or off state and current flow through relays 40 and 42 is terminated. In this manner, relays 40 and 42 of the voltage surge protective circuit V are disabled in the event of excess voltage between hot lead 16 and neutral lead 18, protecting the circuit P and connected apparatus from excessive input voltage.

Thyristor 70 is normally biased to a conductive state and provides electrical current to relays 40 and 42 by a bias network including a capacitor 72 and resistors 74 and 76. An indicator, such as a light-emitting-diode (LED) 78, is provided in the bias network to indicate when the thyristor 70 is conductive and thus relays 40 and 42 are receiving current. An alarm indicator 80, such as an LED, is connected through a resistor 82 and a diode 84 to an anode 70a of the thyristor 70. In the event that contact 42k of relay 42 interrupts the flow of power to the electrical apparatus via the hot conductor 10a, indicator 80 is electrically energized to indicate this alarm condition.

It should be understood also that the relays 40 and 42 may be separately connected individually between the hot lead 10a and neutral lead 12a, rather than in series as shown in the drawing. In this separate connection, each of the relays 40 and 42 are provided with a separate thyristor or other electronic switch functioning like the thyristor 70. Each such separate thyristor or electronic switch is of course provided with its own corresponding bias network of the type described above.

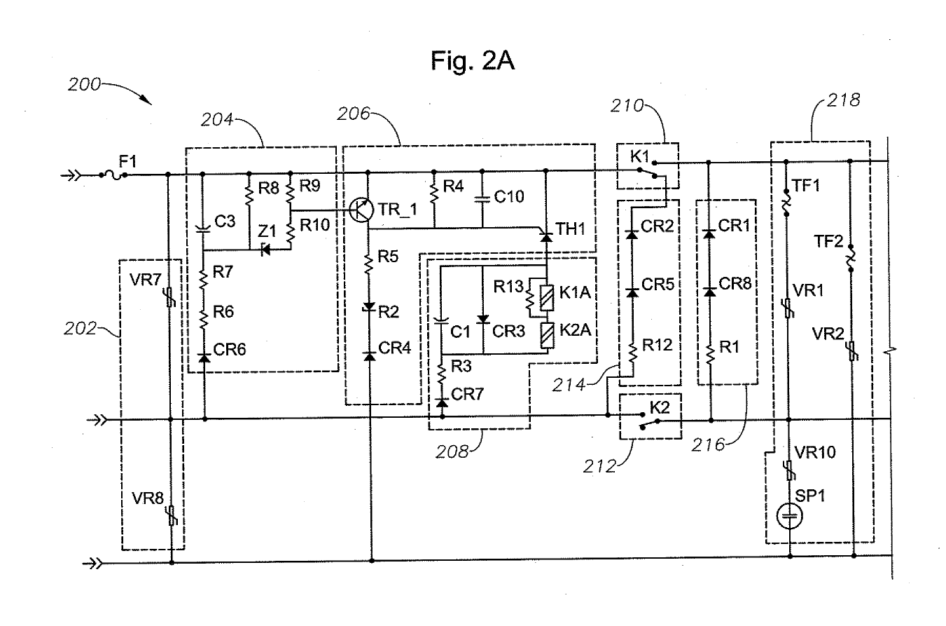

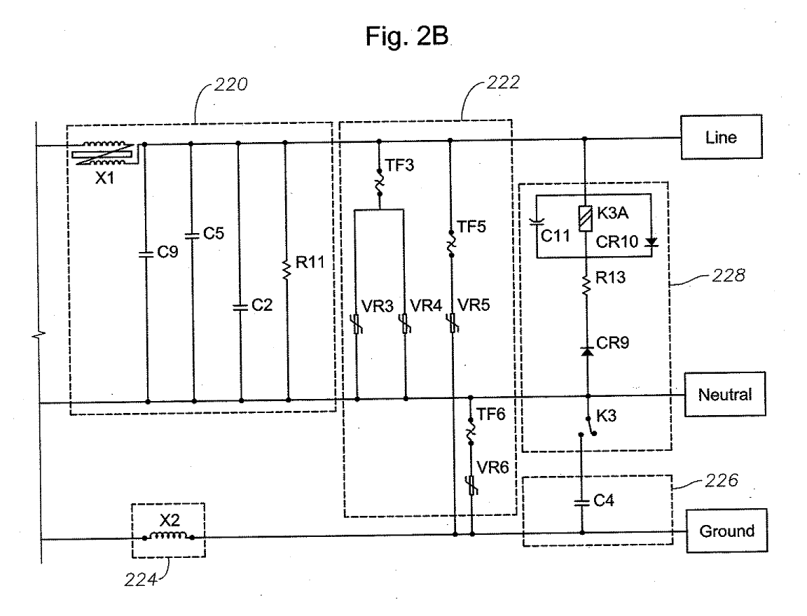

Referring now to FIGS. 2A and 2B, an exemplary embodiment of a transient voltage surge suppressor or transformer base filter 200 that is compatible with a ground fault circuit interrupter is shown.

In an exemplary embodiment, the transient voltage surge suppressor or transformer base filter 200 of FIGS. 2A and 2B includes the following components:

| ITEM | DESCRIPTION | UOM | QTY | REF. |
|---|---|---|---|---|
| 1 | RESISTOR, 1.2K OHM 2 W, | EA | 1 | R3 |
| | M.O. | | | |
| 2 | RESISTOR, 4.7K¼ W C.F | EA | 1 | R7 |
| 3 | RESISTOR, 8.2K ¼ W C.F. | EA | 1 | R8 |
| 4 | RESISTOR, 15K ¼ W | EA | 1 | R4 |
| 5 | RESISTOR, 22K 1 W, M.O. | EA | 2 | R1, R12 |
| 6 | RESISTOR, 4.7K 2 W, M.O. | EA | 1 | R15 |
| 7 | RESISTOR, 39K ¼ W, C.F. | EA | 3 | R9, R10, |
| | | | | R13 |
| 8 | RESISTOR, 82K ¼ W C.F | EA | 1 | R6 |
| 9 | RESISTOR, 1M ¼ W | EA | 1 | R11 |
| 10 | ZENER, 82 V 1 W 5% | EA | 1 | R2 |
| | 1N4762A | | | |
| 11 | RESISTOR, 330K ¼ W C.F | EA | 1 | R5 |
| 12 | CAPACITOR, 2.2 MF/160 VDC | EA | 2 | C3, C1 |
| | ELEC | | | |
| 13 | CAPACITOR, 1 MF 250 V | EA | 1 | C4 |
| 14 | CAPACITOR, 22 MF/100 VDC | EA | 1 | C11 |
| | ELEC | | | |
| 15 | CAPACITOR, 2.2 MF/305 VAC | EA | 3 | C2, C5, C9 |
| 16 | MOV, 20 MM, 130 V | EA | 6 | VR1--6 |
| 17 | MOV, 14 MM, 35 VDC | EA | 1 | VR10 |
| 18 | MOV, 14 MM, 250 V | EA | 2 | VR7, VR8 |
| 19 | DIODE, IN4006 | EA | 8 | CR3--CR10 |
| 20 | DIODE ZENER, 5.1 V | EA | 1 | Z1 |
| 21 | FUSE, 20 A/250 VAC | EA | 1 | F1 |
| 22 | TRANSISTOR, 2N4401 | EA | 1 | TR_1 |
| 23 | THYRISTOR, 0.8 A/600 V | EA | 1 | TH1 |
| 24 | THERMAL FUSE, 5 A/250 V | EA | 5 | TF1-TF3, |
| | | | | TF5, TF6 |
| 25 | LED, RED | EA | 1 | CR2 |
| 26 | LED, GREEN | EA | 1 | CR1 |
| 27 | RELAY, 48 VDC/20 A | EA | 2 | K1, K2 |
| 28 | RELAY 3 A/48 VDC TIAMBO | EA | 1 | K3 |
| 29 | TRANSFORMER IN SERIES | EA | 1 | X1 |
| | W/LINE CIRCUIT | | | |
| 30 | TOROID 14AWG/35Turns | EA | 1 | X2 |
| 31 | GAS TUBE, 230 V | EA | 1 | SP1 |

In an exemplary embodiment, the transient voltage surge suppressor or transformer base filter 200 the following functional elements: 1) a first stage surge arrestor 202; 2) an over voltage detection circuit 204; 3) a no ground and reverse polarity detection and control circuit 206; 4) power relays actuator and coils 208; 5) a line circuit disconnecting relay 210; 6) a neutral circuit disconnecting relay 212; 7) a red LED indicator circuit for fault detection 214; 8) a green LED indicator circuit for normal condition 216; 9) a second stage MOV-gas tube surge arrestor 218; 10) noise attenuation, transformer and capacitor tank 220; 11) third stage surge arrestor 222; 12) ground toroid coil inductance 224; 13) neutral to ground noise filter capacitor tank 226; and 14) relay circuit for connecting the capacitor across neutral 228.

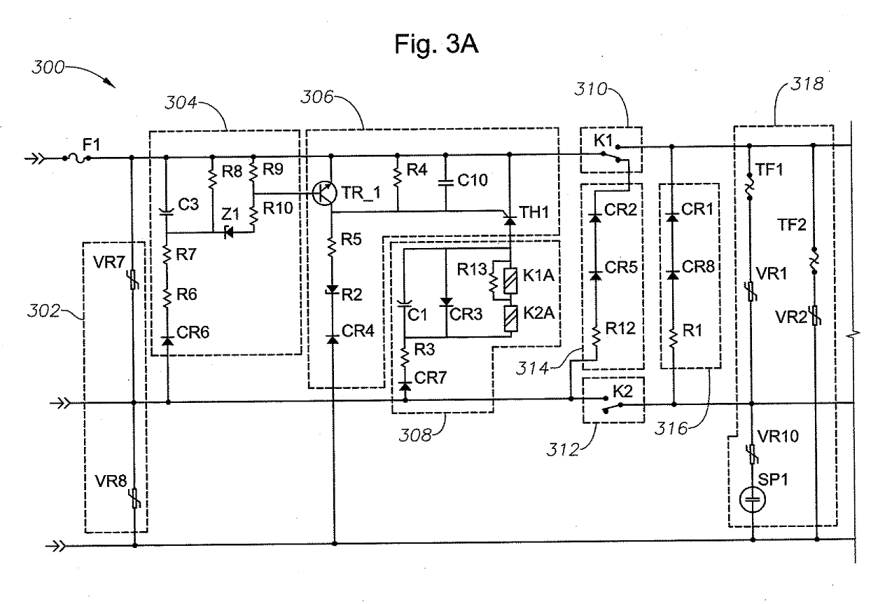

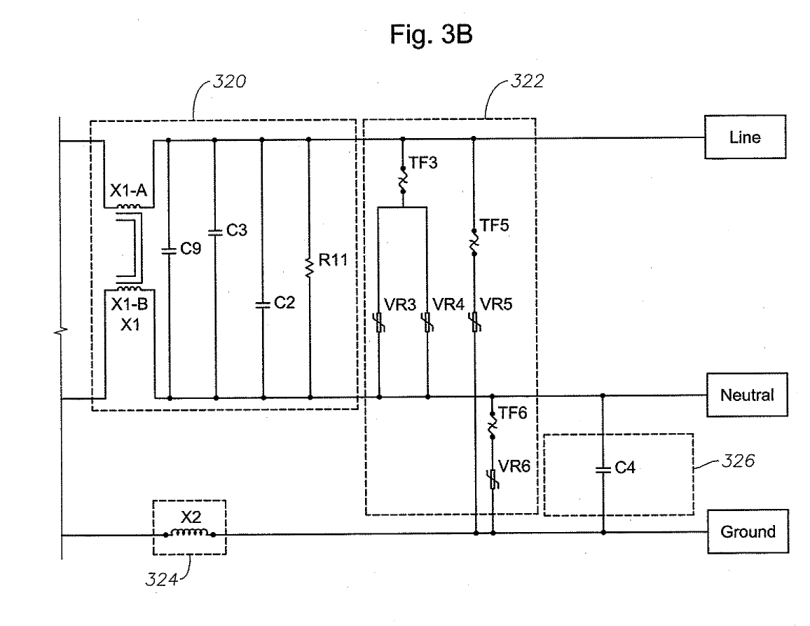

Referring now to FIGS. 3A and 3B, an exemplary embodiment of a transient voltage surge suppressor or transformer base filter 300 that is compatible with a ground fault circuit interrupter is shown.

In an exemplary embodiment, the transient voltage surge suppressor or transformer base filter 300 of FIGS. 3A and 3B includes the following components:

| ITEM | DESCRIPTION | UOM | QTY | REF. |
|---|---|---|---|---|
| 1 | RESISTOR, 1.2K OHM 2 W, | EA | 1 | R3 |
| | M.O. | | | |
| 2 | RESISTOR, 4.7K¼ W C.F | EA | 1 | R7 |
| 3 | RESISTOR, 8.2K ¼ W C.F. | EA | 1 | R8 |
| 4 | RESISTOR, 15K ¼ W | EA | 1 | R4 |
| 5 | RESISTOR, 22K 1 W, M.O. | EA | 2 | R1, R12 |
| 6 | RESISTOR, 39K ¼ W, C.F. | EA | 2 | R9, R10, |
| | | | | R13 |
| 7 | RESISTOR, 82K ¼ W C.F | EA | 1 | R6 |
| 8 | RESISTOR, 1M ¼ W | EA | 1 | R11 |
| 9 | ZENER, 82 V 1 W 5% | EA | 1 | R2 |
| | 1N4762A | | | |
| 10 | RESISTOR, 330K ¼ W C.F | EA | 1 | R5 |
| 11 | CAPACITOR, 2.2 MF/160 VDC | EA | 2 | C3, C1 |
| | ELEC | | | |
| 12 | CAPACITOR, 1 MF 250 V | EA | 1 | C4 |
| 13 | CAPACITOR, 2.2 MF/305 VAC | EA | 3 | C2, C5, C9 |
| 14 | MOV, 20 MM, 130 V | EA | 6 | VR1--6 |
| 15 | MOV, 14 MM, 35 VDC | EA | 1 | VR10 |
| 16 | MOV, 14 MM, 250 V | EA | 2 | VR7, VR8 |
| 17 | DIODE, IN4006 | EA | 6 | CR3--CR8 |
| 18 | DIODE ZENER, 5.1 V | EA | 1 | Z1 |
| 19 | FUSE, 20 A/250 VAC | EA | 1 | F1 |
| 20 | TRANSISTOR, 2N4401 | EA | 1 | TR_1 |
| 21 | THYRISTOR, 0.8 A/600 V | EA | 1 | TH1 |
| 22 | THERMAL FUSE, 5 A/250 V | EA | 5 | TF1-TF3, |
| | | | | TF5, TF6 |
| 23 | LED, RED | EA | 1 | CR2 |
| 24 | LED, GREEN | EA | 1 | CR1 |
| 25 | RELAY, 48 VDC/20 A | EA | 2 | K1, K2 |
| 26 | DIFFERENTIAL | EA | 1 | X1-A/B |
| | TRANSFORMER | | | |
| 27 | TOROID 14AWG/35Turns | EA | 1 | X2 |
| 28 | GAS TUBE, 230 V | EA | 1 | SP1 |

In an exemplary embodiment, the transient voltage surge suppressor or transformer base filter 300 the following functional elements: 1) a first stage surge arrestor 302; 2) an over voltage detection circuit 304; 3) a no ground and reverse polarity detection and control circuit 306; 4) power relays actuator and coils 308; 5) a line circuit disconnecting relay 310; 6) a neutral circuit disconnecting relay 312; 7) a red LED indicator circuit for fault detection 314; 8) a green LED indicator circuit for normal condition 316; 9) a second stage MOV-gas tube surge arrestor 318; 10) noise attenuation transformer and capacitor tank 320; 11) third stage surge arrestor 322; 12) ground torpid coil inductance 324; and 13) neutral to ground noise filter capacitor tank 326.

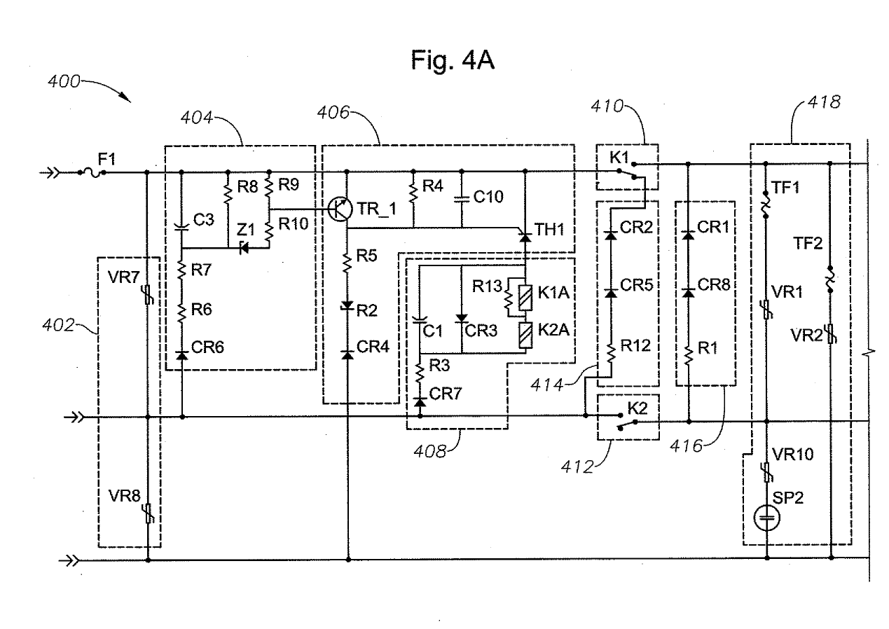

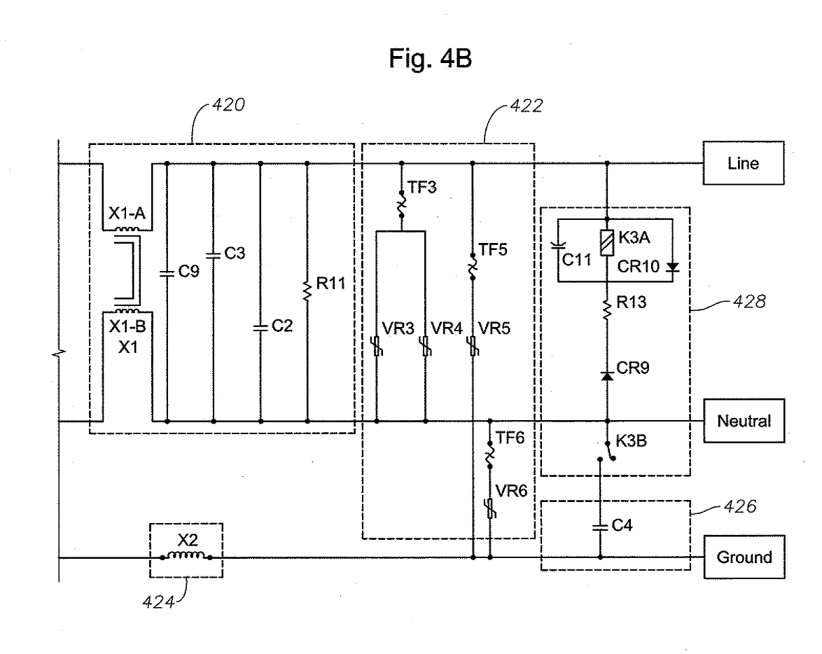

Referring now to FIGS. 4A and 4B, an exemplary embodiment of a transient voltage surge suppressor or transformer base filter 400 that is compatible with a ground fault circuit interrupter is shown.

In an exemplary embodiment, the transient voltage surge suppressor or transformer base filter 400 of FIGS. 4A and 4B includes the following components:

| ITEM | DESCRIPTION | UOM | QTY | REF. |
|---|---|---|---|---|
| 1 | RESISTOR, 1.2K OHM 2 W, | EA | 1 | R3 |
| | M.O. | | | |
| 2 | RESISTOR, 4.7K¼ W C.F | EA | 1 | R7 |
| 3 | RESISTOR, 8.2K ¼ W C.F. | EA | 1 | R8 |
| 4 | RESISTOR, 15K ¼ W | EA | 1 | R4 |
| 5 | RESISTOR, 22K 1 W, M.O. | EA | 2 | R1, R12 |
| 6 | RESISTOR, 4.7K 2 W, M.O. | EA | 1 | R15 |
| 7 | RESISTOR, 39K ¼ W, C.F. | EA | 3 | R9, R10, |
| | | | | R13 |
| 8 | RESISTOR, 82K ¼ W C.F | EA | 1 | R6 |
| 9 | RESISTOR, 1M ¼ W | EA | 1 | R11 |
| 10 | ZENER, 82 V 1 W 5% | EA | 1 | R2 |
| | 1N4762A | | | |
| 11 | RESISTOR, 330K ¼ W C.F | EA | 1 | R5 |
| 12 | CAPACITOR, 2.2 MF/160 VDC | EA | 2 | C3, C1 |
| | ELEC | | | |
| 13 | CAPACITOR, 1 MF 250 V | EA | 1 | C4 |
| 14 | CAPACITOR, 22 MF/100 VDC | EA | 1 | C11 |
| | ELEC | | | |
| 15 | CAPACITOR, 2.2 MF/305 VAC | EA | 3 | C2, C5, C9 |
| 16 | MOV, 20 MM, 130 V | EA | 6 | VR1--6 |
| 17 | MOV, 14 MM, 35 VDC | EA | 1 | VR10 |
| 18 | MOV, 14 MM, 250 V | EA | 2 | VR7, VR8 |
| 19 | DIODE, IN4006 | EA | 8 | CR3--CR10 |
| 20 | DIODE ZENER, 5.1 V | EA | 1 | Z1 |
| 21 | FUSE, 20 A/250 VAC | EA | 1 | F1 |
| 22 | TRANSISTOR, 2N4401 | EA | 1 | TR_1 |
| 23 | THYRISTOR, 0.8 A/600 V | EA | 1 | TH1 |
| 24 | THERMAL FUSE, 5 A/250 V | EA | 5 | TF1-TF3, |
| | | | | TF5, TF6 |
| 25 | LED, RED | EA | 1 | CR2 |
| 26 | LED, GREEN | EA | 1 | CR1 |
| 27 | RELAY, 48 VDC/20 A | EA | 2 | K1, K2 |
| 28 | RELAY 3 A/48 VDC TIAMBO | EA | 1 | K3 |
| 29 | DIFFERENTIAL | EA | 1 | X1-A/B |
| | TRANSFORMER | | | |
| 30 | TOROID 14AWG/35Turns | EA | 1 | X2 |
| 31 | GAS TUBE, 230 V | EA | 1 | SP1 |

In an exemplary embodiment, the transient voltage surge suppressor or transformer base filter 400 the following functional elements: 1) a first stage surge arrestor 402; 2) an over voltage detection circuit 404; 3) a no ground and reverse polarity detection and control circuit 406; 4) power relays actuator and coils 408; 5) a line circuit disconnecting relay 410; 6) a neutral circuit disconnecting relay 412; 7) a red LED indicator circuit for fault detection 414; 8) a green LED indicator circuit for normal condition 416; 9) a second stage MOV-gas tube surge arrestor 418; 10) noise attenuation transformer and capacitor tank 420; 11) third stage surge arrestor 422; 12) ground toroid coil inductance 424; 13) neutral to ground noise filter capacitor tank 426; and 14) relay circuit for connecting the capacitor across neutral 428.

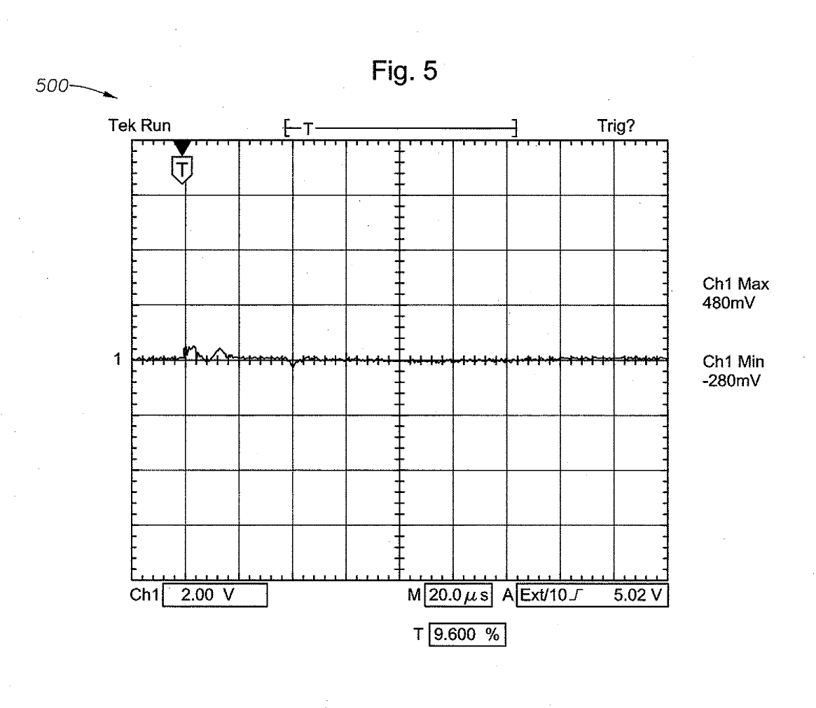

Referring now to FIG. 5, in an exemplary experimental embodiment of the protective circuit P, the capacitor C4 of the neutral to ground noise filer capacitor tank 226, 326 and 426, respectively, was equal to 10 microfarads. A transient waveform in the form of a IEEE 62.41 Category A 3 KV/200 A ring wave was applied across the neutral 12 and ground 14 of the protective circuit P. As illustrated in 5, during the exemplary experimental embodiment of the protective circuit P, a signal 500 was present across the common 12 and ground 14 of the protective circuit. In the exemplary experimental embodiments of the protective circuit P, the maximum voltage across the common 12 and ground 14 of the protective circuit P was 0.48 volts. This was an unexpected result.

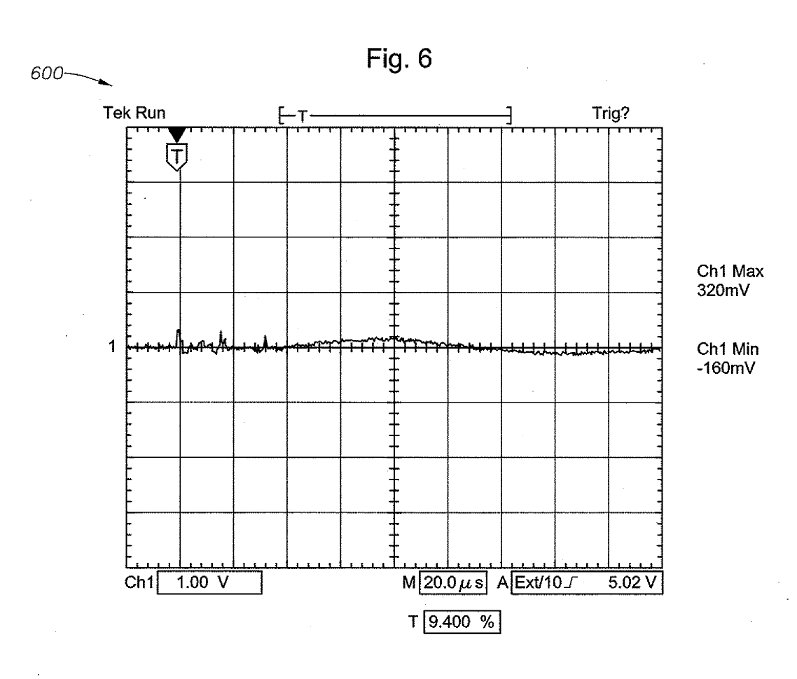

Referring now to FIG. 6, in an exemplary experimental embodiments of the transient voltage surge suppressor or transformer base filters 200, 300 and 400, the capacitor C4 of the neutral to ground noise filer capacitor tank 226, 326 and 426, respectively, was equal to 1 microfarads. A transient waveform in the form of a IEEE 62.41 Category A 3 KV/200 A ring wave was applied across the neutral and ground of the filter 200. As illustrated in 6, during the exemplary experimental embodiments of the filters 200, 300 and 400, a signal 600 was present across the common 12 and ground 14 of the protective circuit. In the exemplary experimental embodiments of the filters 200, 300 and 400, the maximum voltage across the common and ground of the filters was 0.32 volts. This was an unexpected result.

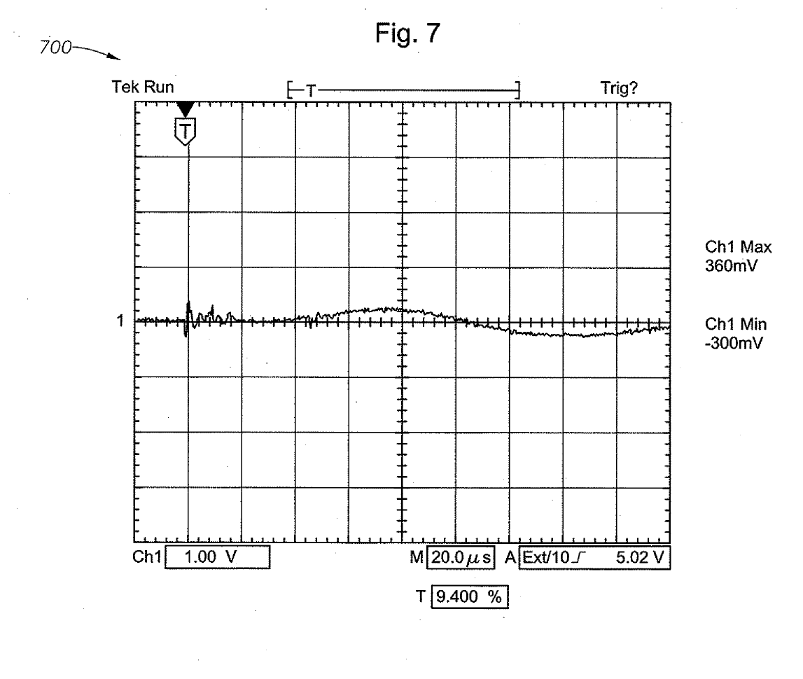

Referring now to FIG. 7, in an exemplary experimental embodiment of the transient voltage surge suppressor or transformer base filters 200, 300 and 400, the capacitor C4 of the neutral to ground noise filer capacitor tank 226, 326 and 426, respectively, was equal to 0.561 microfarads. A transient waveform in the form of a IEEE 62.41 Category A 3 KV/200 A ring wave was applied across the neutral and ground of the filter 200. As illustrated in 6, during the exemplary experimental embodiment of the filters 200, 300 and 400, a signal 600 was present across the common 12 and ground 14 of the protective circuit. In the exemplary experimental embodiments of the filters 200, 300 and 400, the maximum voltage across the common and ground of the filters was 0.36 volts. This was an unexpected result.

In exemplary experimentation embodiments of the transient voltage surge suppressor or transformer base filters 200, 300 and 400, with the capacitor C4 of the neutral to ground noise filer capacitor tank 226, 326 and 426, respectively, equal to 0.561 or 1 microfarads, the filters all complied with UL943 Standard requirement for compliance to GFCI tripping—using 12-14 AWG wiring and 15 A and 20 A branch circuit ratings. In all of the exemplary experimental embodiments of the filters 200, 300 and 400, the ground current I_{g} measured during the UL943 Standard requirement for compliance to GFCI tripping testing was less than 4 mA. This was an unexpected result.

In exemplary experimentation embodiments of the transient voltage surge suppressor or transformer base filters 200, 300 and 400, the capacitor C4 of the neutral to ground noise filer capacitor tank 226, 326 and 426, respectively, is less than or equal to 1.8 uF for 15 A branch circuit ratings and 1.4 uF for 20 A branch circuit ratings, using 12-14 AWG wire size. In exemplary experimentation embodiments of the transient voltage surge suppressor or transformer base filters 200, 300 and 400, with regard to circuits using 10 AWG wire size, the capacitor C4 of the neutral to ground noise filer capacitor tank 226, 326 and 426, respectively, is less than or equal 2.8 uF and 2.2 uF for 15 A and 20 A branch circuit ratings, respectively.

In exemplary experimentation embodiments of the transient voltage surge suppressor or transformer base filters 200, 300 and 400, the inductor X2 of the ground toroid coil inductance 224, 324, 424, respectively, has a wire size that is great than or equal to the wire size of the line and neutral conductors for the power filters. For example, the wire size of the inductor X2 of the ground toroid coil inductance 224, 324, 424 is greater than or equal to 14 AWG for the 15 A rated and 12 AWG for 20 A rated transient voltage surge suppressor or transformer base filters 200, 300 and 400.

In exemplary experimentation embodiments of the transient voltage surge suppressor or transformer base filters 200, 300 and 400, the total impedance of the grounding path within the filters, including the inductor X2 of the ground toroid coil inductance 224, 324, 424, is less than or equal to 0.1 Ohm at a typical power frequency (60 HZ) when 25 A/60 HZ current passes through the grounding path.

In several exemplary embodiments, the inductor X2 of the ground toroid coil inductance 224, 324, 424, may be constructed from a toroidal core, a rod core, and/or an iron core coils or inductors.

A protective circuit having hot, neutral, and ground leads arranged to be placed between corresponding hot, neutral, and ground leads of a power utility outlet and corresponding hot, neutral, and ground leads of a electrical apparatus has been described that includes a voltage surge protection circuit connected between the hot and neutral leads, that includes: first and second voltage surge protectors connected in series between the hot and neutral leads, said first and second voltage surge protectors being connected at a common connection to each other, and a first relay connected between the hot and neutral leads of the protective circuit and controlling a first relay switch arm which connects the common connection of the first and second voltage surge protectors to an electrical path to ground when the first relay is receiving current, said first relay receiving current when the ground lead is connected to an electrical ground, and said first relay switch arm opening when current in the first relay circuit is not received to protect the voltage surge protectors of the voltage surge protector circuit when the ground lead is not connected to an electrical ground, wherein when a 3 KV and 200 A transient input is applied across the neutral and ground leads of the power utility outlet, a peak voltage of less than or equal to 0.36 V is provided across the neutral and ground leads of the electrical apparatus. In an exemplary embodiment, the protective circuit further includes a capacitor connected between said common connection of said first and second voltage protectors in said voltage surge protection circuit and said neutral lead, said capacitor having a farad rating to filter substantially all noise signals on said neutral lead to ground when said ground lead of said circuit is connected to electrical ground through said first relay switch arm. In an exemplary embodiment, the capacitor connected between said common connection of said first and second voltage protectors has a value less than or equal to 1 microfarad. In an exemplary embodiment, the capacitor connected between said common connection of said first and second voltage protectors has a value ranging from about 0.5 to 1 microfarad. In an exemplary embodiment, the protective circuit further includes a voltage threshold sensing circuit for detecting when the voltage on the hot lead of the power utility outlet exceeds an established protective level; a relay supply switch for providing current to the relay circuit; and an electronic switch responsive to the voltage threshold sensing circuit for disabling the relay supply switch and protecting the electrical apparatus when the voltage between the hot lead and the neutral lead of the power utility outlet exceeds an established protective level. In an exemplary embodiment, the protective circuit further includes a voltage threshold sensing circuit for detecting when the voltage between the hot lead and the neutral lead of the power utility outlet exceeds an established protective level; a relay supply switch for providing current to the relay circuit; and an electronic switch responsive to the voltage threshold sensing circuit for disabling the relay supply switch and protecting the electrical apparatus when the voltage between the hot lead and the neutral lead of the power utility outlet exceeds an established protective level. In an exemplary embodiment, the protective circuit further includes a voltage threshold sensing circuit for detecting when the voltage on the hot lead of the power utility outlet exceeds an established protective level; a relay supply switch for providing current to the relay circuit; an electronic switch responsive to the voltage threshold sensing circuit for disabling the relay supply switch and protecting the electrical apparatus when the connection between the ground lead is disconnected. In an exemplary embodiment, the protective circuit further includes a voltage threshold sensing circuit for detecting when the voltage on the hot lead of the power utility outlet exceeds an established protective level; a relay supply switch for providing current to the relay circuit; an electronic switch responsive to the voltage threshold sensing circuit for disabling the relay supply switch and protecting the electrical apparatus when the connection between the hot and neutral lead is reversed. In an exemplary embodiment, the first relay receives current when the hot lead and the neutral lead are properly connected and not receiving current when the connection between the hot lead and the neutral lead is reversed, said first relay switch arm opening when current in the first relay circuit is not received to protect the voltage surge protectors of the voltage surge protector circuit when the connection between the hot lead and the neutral lead is reversed, in an exemplary embodiment, the protective circuit further includes a second relay connected between the hot and neutral leads of the protective circuit and controlling a second relay switch arm in a conductor connecting the hot lead of the power utility outlet to the hot lead of the electrical apparatus when the second relay is receiving current, said second relay receiving current when the ground lead is connected to an electrical ground, said second relay switch arm opening when current in the second relay circuit is not received to protect the electrical apparatus and the voltage surge protectors of the voltage surge protector circuit when the ground lead is not connected to an electrical ground. In an exemplary embodiment, the protective circuit further includes a second relay connected between the hot and neutral leads of the protective circuit and controlling a second relay switch arm in a conductor connecting the hot lead of the power utility outlet to the hot lead of the electrical apparatus when the second relay is receiving current, said second relay receiving current when the hot lead and the neutral lead are properly connected and not receiving current when connection between the hot lead and the neutral lead is reversed, said second relay switch arm opening when current in the second relay is not received to protect the electrical apparatus and the voltage surge protectors of the voltage surge protector circuit when connection between the hot lead and the neutral lead is reversed.

A protective circuit having hot, neutral, and ground leads arranged to be placed between corresponding hot, neutral, and ground leads of a power utility outlet and corresponding hot, neutral, and ground leads of electrical apparatus has been described that includes a voltage surge protection circuit connected between the hot and neutral leads, including: first and second voltage surge protectors connected in series between the hot and neutral leads, said first and second voltage surge protectors being connected at a common connection to each other; a first relay connected between the hot and neutral leads of the protective circuit and controlling a first relay switch arm which connects the common connection of the first and second voltage surge protectors to an electrical path to ground when the first relay is receiving current, said first relay receiving current when the hot lead and the neutral lead are properly connected and not receiving current when connection between the hot lead and the neutral lead is reversed, said first relay switch arm opening when current in the first relay circuit is not received to protect the voltage surge protectors of the voltage surge protector circuit when the connection between the hot lead and the neutral lead is reversed, wherein when a 3 KV and 200 A transient input is applied across the neutral and ground leads of the power utility outlet, a peak voltage of less than 0.5 V is provided across the neutral and ground leads of the electrical apparatus.

A protective circuit has been described having hot, neutral, and ground leads arranged to be placed between corresponding hot, neutral, and ground leads of a power utility outlet and corresponding hot, neutral, and ground leads of electrical apparatus, said protective circuit including: a voltage surge protection circuit connected between the hot and neutral leads, including: first and second voltage surge protectors connected in series between the hot and neutral leads, said first and second voltage surge protectors being connected at a common connection to each other; a relay connected between the hot and neutral leads of the protective circuit, said relay controlling a relay switch arm in a conductor connecting the hot lead of the power utility outlet to the hot lead of the electrical apparatus when the relay is receiving current, said relay receiving current when the ground lead is connected to an electrical ground, said relay switch arm opening when current is not received to protect the electrical apparatus and the voltage surge protectors of the voltage surge protector circuit when the ground lead is not connected to an electrical ground, wherein when a 3 KV and 200 A transient input is applied across the neutral and ground leads of the power utility outlet, a peak voltage of less than 0.5 V is provided across the neutral and ground leads of the electrical apparatus. In an exemplary embodiment, the protective circuit further includes a voltage threshold sensing circuit for detecting when the voltage between the hot lead and neutral lead of the power utility outlet exceeds an established protective level;

a relay supply switch for providing current to the relay circuit; and an electronic switch responsive to the voltage threshold sensing circuit for disabling the relay supply switch and protecting the electrical apparatus and surge protector components between hot and neutral leads when the voltage on the hot lead of the power utility outlet exceeds an established protective level.

A protective circuit has been described having hot, neutral, and ground leads arranged to be placed between corresponding hot, neutral, and ground leads of a power utility outlet and corresponding hot, neutral, and ground leads of electrical apparatus, said protective circuit including: a voltage surge protection circuit connected between the hot and neutral leads, including: first and second voltage surge protectors connected in series between the hot and neutral leads, said first and second voltage surge protectors being connected at a common connection to each other: a relay connected between the hot and neutral leads of the protective circuit and controlling a relay switch arm in a conductor connecting the hot lead of the power utility outlet to the hot lead of the electrical apparatus when the relay is receiving current, said relay receiving current when the hot lead and the neutral lead are properly connected and not receiving current when connection between the hot lead and the neutral lead is reversed, said relay switch arm opening when current in the relay is not received to protect the electrical apparatus and the voltage surge protectors of the voltage surge protector circuit when the connection between the hot lead and the neutral lead is reversed, wherein when a 3 KV and 200 A transient input is applied across the neutral and ground leads of the power utility outlet, a peak voltage of less than 0.5 V is provided across the neutral and ground leads of the electrical apparatus.

A protective circuit has been described having hot, neutral, and ground leads arranged to be placed between corresponding hot, neutral, and ground leads of a power utility outlet and corresponding hot, neutral, and ground leads of electrical apparatus, said protective circuit including: a voltage threshold sensing circuit for detecting when the voltage on the hot lead of the power utility outlet exceeds an established protective level; a voltage surge protection circuit connected between the leads to protect the electrical apparatus from voltage surges; a relay circuit to protect the voltage surge protection circuit; a relay supply switch for providing current to the relay circuit; and an electronic switch responsive to the voltage threshold sensing circuit for disabling the relay supply switch and protecting the electrical apparatus when the voltage on the hot lead of the power utility outlet exceeds an established protective level, wherein when a 3 KV and 200 A transient input is applied across the neutral and ground leads of the power utility outlet, a peak voltage of less than 0.5 V is provided across the neutral and ground leads of the electrical apparatus. In an exemplary embodiment, the voltage surge protection circuit is connected between the hot and neutral leads. In an exemplary embodiment, the voltage surge protection circuit comprises: first and second voltage surge protectors connected in series between the hot and neutral leads; said first and second voltage surge protectors being connected at a common connection to each other. In an exemplary embodiment, the protective circuit further includes a series connected set of first and second relays connected between the hot and neutral leads of the protective circuit, said first relay controlling a first relay switch arm which connects the common connection of the first and second voltage surge protectors to an electrical path to ground when the first relay is receiving current, said first relay receiving current when the ground lead is connected to an electrical ground, and said first relay switch arm opening when current in the first relay circuit is not received to protect the voltage surge protectors of the voltage surge protector circuit when the ground lead is not connected to an electrical ground. In an exemplary embodiment, the protective circuit further includes a capacitor connected between said common connection of said first and second voltage protectors in said voltage surge protection circuit and said neutral lead, said capacitor having a farad rating to filter substantially all noise signals on said neutral lead to ground when said ground lead of said circuit is connected to electrical ground through said first relay switch arm. In an exemplary embodiment, the capacitor connected between said common connection of said first and second voltage protectors has a value less than or equal to 1 microfarad. In an exemplary embodiment, the capacitor connected between said common connection of said first and second voltage protectors has a value ranging from about 0.5 to 1 microfarad. In an exemplary embodiment, the protective circuit further includes said second relay controlling a second relay switch arm in a conductor connecting the hot lead of the power utility outlet to the hot lead of the electrical apparatus when the second relay is receiving current, said second relay receiving current when the ground lead is connected to an electrical ground, said second relay switch arm opening when current in the first relay circuit is not received to protect the electrical apparatus surge protector components and circuit when the ground lead is not connected to an electrical ground.

A protective circuit has been described having hot, neutral, and ground leads arranged to be placed between corresponding hot, neutral, and ground leads of a power utility outlet and corresponding hot, neutral, and ground leads of a electrical apparatus, said protective circuit including: a voltage surge protection circuit connected between the hot and neutral leads, including: first and second voltage surge protectors connected in series between the hot and neutral leads, said first and second voltage surge protectors being connected at a common connection to each other, and a first relay connected between the hot and neutral leads of the protective circuit and controlling a first relay switch arm which connects the common connection of the first and second voltage surge protectors to an electrical path to ground when the first relay is receiving current, said first relay receiving current when the ground lead is connected to an electrical ground, and said first relay switch arm opening when current in the first relay circuit is not received to protect the voltage surge protectors of the voltage surge protector circuit when the ground lead is not connected to an electrical ground, wherein the protective circuit complies with the UL943 Standard.

A protective circuit has been described having hot, neutral, and ground leads arranged to be placed between corresponding hot, neutral, and ground leads of a power utility outlet and corresponding hot, neutral, and ground leads of electrical apparatus, said protective circuit comprising: a voltage surge protection circuit connected between the hot and neutral leads, comprising: first and second voltage surge protectors connected in series between the hot and neutral leads, said first and second voltage surge protectors being connected at a common connection to each other; a first relay connected between the hot and neutral leads of the protective circuit and controlling a first relay switch arm which connects the common connection of the first and second voltage surge protectors to an electrical path to ground when the first relay is receiving current, said first relay receiving current when the hot lead and the neutral lead are properly connected and not receiving current when connection between the hot lead and the neutral lead is reversed, said first relay switch arm opening when current in the first relay circuit is not received to protect the voltage surge protectors of the voltage surge protector circuit when the connection between the hot lead and the neutral lead is reversed, wherein the protective circuit complies with the UL943 Standard.

A protective circuit has been described having hot, neutral, and ground leads arranged to be placed between corresponding hot, neutral, and ground leads of a power utility outlet and corresponding hot, neutral, and ground leads of electrical apparatus, said protective circuit including: a voltage surge protection circuit connected between the hot and neutral leads, including: first and second voltage surge protectors connected in series between the hot and neutral leads, said first and second voltage surge protectors being connected at a common connection to each other; a relay connected between the hot and neutral leads of the protective circuit, said relay controlling a relay switch arm in a conductor connecting the hot lead of the power utility outlet to the hot lead of the electrical apparatus when the relay is receiving current, said relay receiving current when the ground lead is connected to an electrical ground, said relay switch arm opening when current is not received to protect the electrical apparatus and the voltage surge protectors of the voltage surge protector circuit when the ground lead is not connected to an electrical ground, wherein the protective circuit complies with the UL943 Standard.

A protective circuit having hot, neutral, and ground leads arranged to be placed between corresponding hot, neutral, and ground leads of a power utility outlet and corresponding hot, neutral, and ground leads of electrical apparatus, said protective circuit including: a voltage surge protection circuit connected between the hot and neutral leads, comprising: first and second voltage surge protectors connected in series between the hot and neutral leads, said first and second voltage surge protectors being connected at a common connection to each other: a relay connected between the hot and neutral leads of the protective circuit and controlling a relay switch arm in a conductor connecting the hot lead of the power utility outlet to the hot lead of the electrical apparatus when the relay is receiving current, said relay receiving current when the hot lead and the neutral lead are properly connected and not receiving current when connection between the hot lead and the neutral lead is reversed, said relay switch arm opening when current in the relay is not received to protect the electrical apparatus and the voltage surge protectors of the voltage surge protector circuit when the connection between the hot lead and the neutral lead is reversed, wherein the protective circuit complies with the UL943 Standard.

A protective circuit has been described having hot, neutral, and ground leads arranged to be placed between corresponding hot, neutral, and ground leads of a power utility outlet and corresponding hot, neutral, and ground leads of electrical apparatus, said protective circuit including: a voltage threshold sensing circuit for detecting when the voltage on the hot lead of the power utility outlet exceeds an established protective level; a voltage surge protection circuit connected between the leads to protect the electrical apparatus from voltage surges; a relay circuit to protect the voltage surge protection circuit; a relay supply switch for providing current to the relay circuit; and an electronic switch responsive to the voltage threshold sensing circuit for disabling the relay supply switch and protecting the electrical apparatus when the voltage on the hot lead of the power utility outlet exceeds an established protective level, wherein the protective circuit complies with the UL943 Standard.

A protective circuit has been described having hot, neutral, and ground leads arranged to be placed between corresponding hot, neutral, and ground leads of a power utility outlet and corresponding hot, neutral, and ground leads of electrical apparatus, said protective circuit including: first means for surge arresting; second means for surge arresting; the first and second means for surge arresting operably coupled to the neutral leads; means for filtering noise; and means for connecting the means for filtering noise across the neutral and ground leads. In an exemplary embodiment, when a 3 KV and 200 A transient input is applied across the neutral and ground leads of the power utility outlet, a peak voltage of less than or equal to 0.36 V is provided across the neutral and ground leads of the electrical apparatus. In an exemplary embodiment, the protective circuit complies with the UL943 Standard. In an exemplary embodiment, the protective circuit further includes means for over voltage detection. In an exemplary embodiment, the protective circuit further includes means for no ground and reverse polarity and control. In an exemplary embodiment, the protective circuit further includes means for disconnecting the hot leads. In an exemplary embodiment, the protective circuit further includes means for disconnecting the neutral leads. In an exemplary embodiment, the protective circuit further includes means for indicating a fault condition. In an exemplary embodiment, the protective circuit further includes means for indicating a normal condition. In an exemplary embodiment, the protective circuit further includes third means for surge arresting.

A protective circuit has been described having hot, neutral, and ground leads arranged to be placed between corresponding hot, neutral, and ground leads of a power utility outlet and corresponding hot, neutral, and ground leads of electrical apparatus, said protective circuit including first means for surge arresting; second means for surge arresting; the first and second means for surge arresting operably coupled to the neutral leads; means for filtering noise; means for connecting the means for filtering noise across the neutral and ground leads; means for over voltage detection; means for no ground and reverse polarity and control; means for disconnecting the hot leads; means for disconnecting the neutral leads; means for indicating a fault condition; means for indicating a normal condition; and third means for surge arresting. In an exemplary embodiment, when a 3 KV and 200 A transient input is applied across the neutral and ground leads of the power utility outlet, a peak voltage of less than or equal to 0.36 V is provided across the neutral and ground leads of the electrical apparatus. In an exemplary embodiment, the protective circuit complies with the UL943 Standard.

It is understood that variations may be made in the above without departing from the scope of the invention. While specific embodiments have been shown and described, modifications can be made by one skilled in the art without departing from the spirit or teaching of this invention. The embodiments as described are exemplary only and are not limiting. Many variations and modifications are possible and are within the scope of the invention. Furthermore, one or more elements of the exemplary embodiments may be omitted, combined with, or substituted for, in whole or in part, one or more elements of one or more of the other exemplary embodiments. Accordingly, the scope of protection is not limited to the embodiments described, but is only limited by the claims that follow, the scope of which shall include all equivalents of the subject matter of the claims.

1. A protective circuit having hot, neutral, and ground leads arranged to be placed between corresponding hot, neutral, and ground leads of a power utility outlet and corresponding hot, neutral, and ground leads of a electrical apparatus, said protective circuit comprising:
a voltage surge protection circuit connected between the hot and neutral leads, comprising:
first and second voltage surge protectors connected in series between the hot and neutral leads,
said first and second voltage surge protectors being connected at a common connection to each other,
a first relay connected between the hot and neutral leads of the protective circuit and controlling a first relay switch arm which connects the common connection of the first and second voltage surge protectors to an electrical path to ground when the first relay is receiving current, said first relay receiving current when the ground lead is connected to an electrical ground, and said first relay switch arm opening when current in the first relay circuit is not received to protect the voltage surge protectors of the voltage surge protector circuit when the ground lead is not connected to an electrical ground, and
a capacitor connected between said common connection of said first and second voltage protectors in said voltage surge protection circuit and said neutral lead, said capacitor having a farad rating to filter substantially all noise signals on said neutral lead to ground when said ground lead of said circuit is connected to electrical ground through said first relay switch arm,
wherein when a 3 KV and 200 A transient input is applied across the neutral and ground leads of the power utility outlet, a peak voltage of less than or equal to 0.50 V is provided across the neutral and ground leads of the electrical apparatus.

2. The protective circuit of claim 1, wherein the capacitor connected between said common connection of said first and second voltage protectors has a value less than or equal to 2.8 microfarad.

3. The protective circuit of claim 1, wherein the capacitor connected between said common connection of said first and second voltage protectors has a value ranging from about 0.50 to 2.8 microfarad.

4. The protective circuit of claim 1, further including:
a voltage threshold sensing circuit for detecting when the voltage on the hot lead of the power utility outlet exceeds an established protective level;
a relay supply switch for providing current to the relay circuit; and
an electronic switch responsive to the voltage threshold sensing circuit for disabling the relay supply switch and protecting the electrical apparatus when the voltage between the hot lead and the neutral lead of the power utility outlet exceeds an established protective level.

5. The protective circuit of claim 1, further including:
a voltage threshold sensing circuit for detecting when the voltage between the hot lead and the neutral lead of the power utility outlet exceeds an established protective level;
a relay supply switch for providing current to the relay circuit; and
an electronic switch responsive to the voltage threshold sensing circuit for disabling the relay supply switch and protecting the electrical apparatus when the voltage between the hot lead and the neutral lead of the power utility outlet exceeds an established protective level.

6. The protective circuit of claim 1, further including:
a voltage threshold sensing circuit for detecting when the voltage on the hot lead of the power utility outlet exceeds an established protective level;
a relay supply switch for providing current to the relay circuit;
an electronic switch responsive to the voltage threshold sensing circuit for disabling the relay supply switch and protecting the electrical apparatus when the connection between the ground lead is disconnected.

7. The protective circuit of claim 1, further including:
a voltage threshold sensing circuit for detecting when the voltage on the hot lead of the power utility outlet exceeds an established protective level;
a relay supply switch for providing current to the relay circuit;
an electronic switch responsive to the voltage threshold sensing circuit for disabling the relay supply switch and protecting the electrical apparatus when the connection between the hot and neutral lead is reversed.

8. The protective circuit of claim 1, wherein:
said first relay receives current when the hot lead and the neutral lead are properly connected and not receiving current when the connection between the hot lead and the neutral lead is reversed, said first relay switch arm opening when current in the first relay circuit is not received to protect the voltage surge protectors of the voltage surge protector circuit when the connection between the hot lead and the neutral lead is reversed.

9. The protective circuit of claim 1, further including:
a second relay connected between the hot and neutral leads of the protective circuit and controlling a second relay switch arm in a conductor connecting the hot lead of the power utility outlet to the hot lead of the electrical apparatus when the second relay is receiving current, said second relay receiving current when the ground lead is connected to an electrical ground, said second relay switch arm opening when current in the second relay circuit is not received to protect the electrical apparatus and the voltage surge protectors of the voltage surge protector circuit when the ground lead is not connected to an electrical ground.

10. The protective circuit of claim 1, further including:
a second relay connected between the hot and neutral leads of the protective circuit and controlling a second relay switch arm in a conductor connecting the hot lead of the power utility outlet to the hot lead of the electrical apparatus when the second relay is receiving current, said second relay receiving current when the hot lead and the neutral lead are properly connected and not receiving current when connection between the hot lead and the neutral lead is reversed, said second relay switch arm opening when current in the second relay is not received to protect the electrical apparatus and the voltage surge protectors of the voltage surge protector circuit when connection between the hot lead and the neutral lead is reversed.

11. The protective circuit of claim 1, wherein an I_{g} current during a UL943 test for compliance a GFCI tripping requirement is less than 4 mA.

12. The protective circuit of claim 1, wherein the capacitance of the capacitor is less than or equal to about 1.8 uF for a 15 A branch circuit.

13. The protective circuit of claim 1, wherein the capacitance of the capacitor is less than or equal to about 1.4 uF for a 20 A branch circuit.

14. The protective circuit of claim 1, wherein the capacitance of the capacitor is less than or equal to about 2.8 uF for a 15 A branch circuit.

15. The protective circuit of claim 1, wherein the capacitance of the capacitor is less than or equal to about 2.2 uF for a 20 A branch circuit.

16. The protective circuit of claim 1, further comprising an inductor connected between the ground leads of the power utility outlet and the electrical apparatus and operably coupled to the capacitor.

17. The protective circuit of claim 1, wherein a wire size of the inductor is greater than or equal to a wire size of conductors for each of the hot and neutral leads of the protective circuit.

18. The protective circuit of claim 1, wherein a total impedance of a grounding path within the protective circuit is less than or equal to 0.1 ohm at a frequency of 60 Hz.

19. A protective circuit having hot, neutral, and ground leads arranged to be placed between corresponding hot, neutral, and ground leads of a power utility outlet and corresponding hot, neutral, and ground leads of electrical apparatus, said protective circuit comprising:
a voltage surge protection circuit connected between the hot and neutral leads, comprising:
first and second voltage surge protectors connected in series between the hot and neutral leads,
said first and second voltage surge protectors being connected at a common connection to each other;
a first relay connected between the hot and neutral leads of the protective circuit and controlling a first relay switch arm which connects the common connection of the first and second voltage surge protectors to an electrical path to ground when the first relay is receiving current, said first relay receiving current when the hot lead and the neutral lead are properly connected and not receiving current when connection between the hot lead and the neutral lead is reversed, said first relay switch arm opening when current in the first relay circuit is not received to protect the voltage surge protectors of the voltage surge protector circuit when the connection between the hot lead and the neutral lead is reversed, and
a capacitor connected between said common connection of said first and second voltage surge protectors in said voltage surge protection circuit and said neutral lead, said capacitor having a farad rating to filter substantially all noise signals on said neutral lead to ground when said ground lead of said circuit is connected to electrical ground through said first relay switch arm,
wherein when a 3 KV and 200 A transient input is applied across the neutral and ground leads of the power utility outlet, a peak voltage of less than 0.5 V is provided across the neutral and ground leads of the electrical apparatus.

20. A protective circuit having hot, neutral, and ground leads arranged to be placed between corresponding hot, neutral, and ground leads of a power utility outlet and corresponding hot, neutral, and ground leads of electrical apparatus, said protective circuit comprising:
a voltage surge protection circuit connected between the hot and neutral leads, comprising:
first and second voltage surge protectors connected in series between the hot and neutral leads,
said first and second voltage surge protectors being connected at a common connection to each other;
a relay connected between the hot and neutral leads of the protective circuit, said relay controlling a relay switch arm in a conductor connecting the hot lead of the power utility outlet to the hot lead of the electrical apparatus when the relay is receiving current, said relay receiving current when the ground lead is connected to an electrical ground, said relay switch arm opening when current is not received to protect the electrical apparatus and the voltage surge protectors of the voltage surge protector circuit when the ground lead is not connected to an electrical ground, and
a capacitor connected between said common connection of said first and second voltage surge protectors in said voltage surge protection circuit and said neutral lead, said capacitor having a farad rating to filter substantially all noise signals on said neutral lead to ground when said ground lead of said circuit is connected to electrical ground through said first relay switch arm,
wherein when a 3 KV and 200 A transient input is applied across the neutral and ground leads of the power utility outlet, a peak voltage of less than 0.5 V is provided across the neutral and ground leads of the electrical apparatus.

21. The protective circuit of claim 20, further including:
a voltage threshold sensing circuit for detecting when the voltage between the hot lead and neutral lead of the power utility outlet exceeds an established protective level;
a relay supply switch for providing current to the relay circuit; and
an electronic switch responsive to the voltage threshold sensing circuit for disabling the relay supply switch and protecting the electrical apparatus and surge protector components between hot and neutral leads when the voltage on the hot lead of the power utility outlet exceeds an established protective level.

22. A protective circuit having hot, neutral, and ground leads arranged to be placed between corresponding hot, neutral, and ground leads of a power utility outlet and corresponding hot, neutral, and ground leads of electrical apparatus, said protective circuit comprising:
a voltage surge protection circuit connected between the hot and neutral leads, comprising:
first and second voltage surge protectors connected in series between the hot and neutral leads,
said first and second voltage surge protectors being connected at a common connection to each other:
a relay connected between the hot and neutral leads of the protective circuit and controlling a relay switch arm in a conductor connecting the hot lead of the power utility outlet to the hot lead of the electrical apparatus when the relay is receiving current, said relay receiving current when the hot lead and the neutral lead are properly connected and not receiving current when connection between the hot lead and the neutral lead is reversed, said relay switch arm opening when current in the relay is not received to protect the electrical apparatus and the voltage surge protectors of the voltage surge protector circuit when the connection between the hot lead and the neutral lead is reversed, and
a capacitor connected between said common connection of said first and second voltage surge protectors in said voltage surge protection circuit and said neutral lead, said capacitor having a farad rating to filter substantially all noise signals on said neutral lead to ground when said ground lead of said circuit is connected to electrical ground through said first relay switch arm,
wherein when a 3 KV and 200 A transient input is applied across the neutral and ground leads of the power utility outlet, a peak voltage of less than 0.5 V is provided across the neutral and ground leads of the electrical apparatus.

23. A protective circuit having hot, neutral, and ground leads arranged to be placed between corresponding hot, neutral, and ground leads of a power utility outlet and corresponding hot, neutral, and ground leads of electrical apparatus, said protective circuit comprising:
a voltage threshold sensing circuit for detecting when the voltage on the hot lead of the power utility outlet exceeds an established protective level;
a voltage surge protection circuit connected between the leads to protect the electrical apparatus from voltage surges;
a relay circuit to protect the voltage surge protection circuit;
a relay supply switch for providing current to the relay circuit;
an electronic switch responsive to the voltage threshold sensing circuit for disabling the relay supply switch and protecting the electrical apparatus when the voltage on the hot lead of the power utility outlet exceeds an established protective level, and
a capacitor connected between said common connection of said first and second voltage surge protectors in said voltage surge protection circuit and said neutral lead, said capacitor having a farad rating to filter substantially all noise signals on said neutral lead to ground when said ground lead of said circuit is connected to electrical ground through said first relay switch arm,
wherein when a 3 KV and 200 A transient input is applied across the neutral and ground leads of the power utility outlet, a peak voltage of less than 0.5 V is provided across the neutral and ground leads of the electrical apparatus.

24. The protective circuit of claim 23, wherein the voltage surge protection circuit is connected between the hot and neutral leads.

25. The protective circuit of claim 24, wherein the voltage surge protection circuit comprises:
first and second voltage surge protectors connected in series between the hot and neutral leads;
said first and second voltage surge protectors being connected at a common connection to each other.

26. The protective circuit of claim 25, further including:
a series connected set of first and second relays connected between the hot and neutral leads of the protective circuit, said first relay controlling a first relay switch arm which connects the common connection of the first and second voltage surge protectors to an electrical path to ground when the first relay is receiving current, said first relay receiving current when the ground lead is connected to an electrical ground, and said first relay switch arm opening when current in the first relay circuit is not received to protect the voltage surge protectors of the voltage surge protector circuit when the ground lead is not connected to an electrical ground.

27. The protective circuit of claim 23, wherein the capacitor connected between said common connection of said first and second voltage protectors has a value less than or equal to 2.8 microfarad.

28. The protective circuit of claim 23, wherein the capacitor connected between said common connection of said first and second voltage protectors has a value ranging from about 0.5 to 2.8 microfarad.

29. The protective circuit of claim 23, further including:
said second relay controlling a second relay switch arm in a conductor connecting the hot lead of the power utility outlet to the hot lead of the electrical apparatus when the second relay is receiving current, said second relay receiving current when the ground lead is connected to an electrical ground, said second relay switch arm opening when current in the first relay circuit is not received to protect the electrical apparatus surge protector components and circuit when the ground lead is not connected to an electrical ground.

30. A protective circuit having hot, neutral, and ground leads arranged to be placed between corresponding hot, neutral, and ground leads of a power utility outlet and corresponding hot, neutral, and ground leads of a electrical apparatus, said protective circuit comprising:
a voltage surge protection circuit connected between the hot and neutral leads, comprising:
first and second voltage surge protectors connected in series between the hot and neutral leads,
said first and second voltage surge protectors being connected at a common connection to each other, and
a first relay connected between the hot and neutral leads of the protective circuit and controlling a first relay switch arm which connects the common connection of the first and second voltage surge protectors to an electrical path to ground when the first relay is receiving current, said first relay receiving current when the ground lead is connected to an electrical ground, and said first relay switch arm opening when current in the first relay circuit is not received to protect the voltage surge protectors of the voltage surge protector circuit when the ground lead is not connected to an electrical ground,
wherein the protective circuit complies with the UL943 Standard.

31. A protective circuit having hot, neutral, and ground leads arranged to be placed between corresponding hot, neutral, and ground leads of a power utility outlet and corresponding hot, neutral, and ground leads of electrical apparatus, said protective circuit comprising:
a voltage surge protection circuit connected between the hot and neutral leads, comprising:
first and second voltage surge protectors connected in series between the hot and neutral leads,
said first and second voltage surge protectors being connected at a common connection to each other;
a first relay connected between the hot and neutral leads of the protective circuit and controlling a first relay switch arm which connects the common connection of the first and second voltage surge protectors to an electrical path to ground when the first relay is receiving current, said first relay receiving current when the hot lead and the neutral lead are properly connected and not receiving current when connection between the hot lead and the neutral lead is reversed, said first relay switch arm opening when current in the first relay circuit is not received to protect the voltage surge protectors of the voltage surge protector circuit when the connection between the hot lead and the neutral lead is reversed,
wherein the protective circuit complies with the UL943 Standard.

32. A protective circuit having hot, neutral, and ground leads arranged to be placed between corresponding hot, neutral, and ground leads of a power utility outlet and corresponding hot, neutral, and ground leads of electrical apparatus, said protective circuit comprising:
a voltage surge protection circuit connected between the hot and neutral leads, comprising:
first and second voltage surge protectors connected in series between the hot and neutral leads,
said first and second voltage surge protectors being connected at a common connection to each other;
a relay connected between the hot and neutral leads of the protective circuit, said relay controlling a relay switch arm in a conductor connecting the hot lead of the power utility outlet to the hot lead of the electrical apparatus when the relay is receiving current, said relay receiving current when the ground lead is connected to an electrical ground, said relay switch arm opening when current is not received to protect the electrical apparatus and the voltage surge protectors of the voltage surge protector circuit when the ground lead is not connected to an electrical ground,
wherein the protective circuit complies with the UL943 Standard.

33. A protective circuit having hot, neutral, and ground leads arranged to be placed between corresponding hot, neutral, and ground leads of a power utility outlet and corresponding hot, neutral, and ground leads of electrical apparatus, said protective circuit comprising:
a voltage surge protection circuit connected between the hot and neutral leads, comprising:
first and second voltage surge protectors connected in series between the hot and neutral leads,
said first and second voltage surge protectors being connected at a common connection to each other:
a relay connected between the hot and neutral leads of the protective circuit and controlling a relay switch arm in a conductor connecting the hot lead of the power utility outlet to the hot lead of the electrical apparatus when the relay is receiving current, said relay receiving current when the hot lead and the neutral lead are properly connected and not receiving current when connection between the hot lead and the neutral lead is reversed, said relay switch arm opening when current in the relay is not received to protect the electrical apparatus and the voltage surge protectors of the voltage surge protector circuit when the connection between the hot lead and the neutral lead is reversed,
wherein the protective circuit complies with the UL943 Standard.

34. A protective circuit having hot, neutral, and ground leads arranged to be placed between corresponding hot, neutral, and ground leads of a power utility outlet and corresponding hot, neutral, and ground leads of electrical apparatus, said protective circuit comprising:
a voltage threshold sensing circuit for detecting when the voltage on the hot lead of the power utility outlet exceeds an established protective level;
a voltage surge protection circuit connected between the leads to protect the electrical apparatus from voltage surges;
a relay circuit to protect the voltage surge protection circuit;
a relay supply switch for providing current to the relay circuit; and
an electronic switch responsive to the voltage threshold sensing circuit for disabling the relay supply switch and protecting the electrical apparatus when the voltage on the hot lead of the power utility outlet exceeds an established protective level,
wherein the protective circuit complies with the UL943 Standard.

35. A protective circuit having hot, neutral, and ground leads arranged to be placed between corresponding hot, neutral, and ground leads of a power utility outlet and corresponding hot, neutral, and ground leads of electrical apparatus, said protective circuit comprising:
first means for surge arresting;
second means for surge arresting;
the first and second means for surge arresting operably coupled to the neutral leads;
means for filtering noise; and
means for connecting the means for filtering noise across the neutral and ground leads.

36. The protective circuit of claim 35, wherein when a 3 KV and 200 A transient input is applied across the neutral and ground leads of the power utility outlet, a peak voltage of less than or equal to 0.50 V is provided across the neutral and ground leads of the electrical apparatus.

37. The protective circuit of claim 35, wherein the protective circuit complies with the UL943 Standard.

38. The protective circuit of claim 35, further comprising:
means for over voltage detection.

39. The protective circuit of claim 35, further comprising:
means for no ground and reverse polarity and control.

40. The protective circuit of claim 35, further comprising:
means for disconnecting the hot leads.

41. The protective circuit of claim 35, further comprising:
means for disconnecting the neutral leads.

42. The protective circuit of claim 35, further comprising:
means for indicating a fault condition.

43. The protective circuit of claim 35, further comprising:
means for indicating a normal condition.

44. The protective circuit of claim 35, further comprising:
third means for surge arresting.

45. A protective circuit having hot, neutral, and ground leads arranged to be placed between corresponding hot, neutral, and ground leads of a power utility outlet and corresponding hot, neutral, and ground leads of electrical apparatus, said protective circuit comprising:
first means for surge arresting;
second means for surge arresting;
the first and second means for surge arresting operably coupled to the neutral leads;
means for filtering noise;
means for connecting the means for filtering noise across the neutral and ground leads;
means for over voltage detection;
means for no ground and reverse polarity and control;
means for disconnecting the hot leads;
means for disconnecting the neutral leads;
means for indicating a fault condition;
means for indicating a normal condition; and
third means for surge arresting.

46. The protective circuit of claim 45, wherein when a 3 KV and 200 A transient input is applied across the neutral and ground leads of the power utility outlet, a peak voltage of less than or equal to 0.50 V is provided across the neutral and ground leads of the electrical apparatus.

47. The protective circuit of claim 45, wherein the protective circuit complies with the UL943 Standard.

48. A protective circuit having hot, neutral, and ground leads arranged to be placed between corresponding hot, neutral, and ground leads of a power utility outlet and corresponding hot, neutral, and ground leads of a electrical apparatus, said protective circuit comprising:
a voltage surge protection circuit connected between the hot and neutral leads, comprising:
first and second voltage surge protectors connected in series between the hot and neutral leads,
said first and second voltage surge protectors being connected at a common connection to each other,
a first relay connected between the hot and neutral leads of the protective circuit and controlling a first relay switch arm which connects the common connection of the first and second voltage surge protectors to an electrical path to ground when the first relay is receiving current, said first relay receiving current when the ground lead is connected to an electrical ground, and said first relay switch arm opening when current in the first relay circuit is not received to protect the voltage surge protectors of the voltage surge protector circuit when the ground lead is not connected to an electrical ground,
a capacitor connected between said common connection of said first and second voltage protectors in said voltage surge protection circuit and said neutral lead, said capacitor having a farad rating to filter substantially all noise signals on said neutral lead to ground when said ground lead of said circuit is connected to electrical ground through said first relay switch arm, and
an inductor connected between the ground leads of the power utility outlet and the electrical apparatus and operably coupled to the capacitor.
